(19) United States
(12) Patent Application Publication
(10) Pub. No.: US 2008/0225172 A1
(43) Pub. Date: Sep. 18, 2008

(54) DIGITAL PHOTO DISPLAY WITH DETACHABLE PHOTO FRAME

(76) Inventor: Kuo Hsiung Chen, Kowloon (HK)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 12/048,212

(22) Filed: Mar. 13, 2008

Related U.S. Application Data
(60) Provisional application No. 60/894,680, filed on Mar. 13, 2007.

(51) Int. Cl. H04N 5/50

(52) U.S. Cl. 348/569; 348/E05.097

(57) ABSTRACT

A digital photo display is provided in the present invention, and the digital photo display comprises a frame and a digital photo display device. The digital photo display device is detachably mounted into the frame. The digital photo display device comprises a display screen, a housing and a support stand. Wherein the display screen is attached to a first side of the housing and the support stand is pivotally attached to a second side of the housing opposite to the first side. The housing encloses electronic components for performing functional operations of the digital photo display device, and the support stand is a rotatable stand.

### CROSS-REFERENCE TO RELATED APPLICATION

This application claims the priority benefit of the U.S. Provisional Application Ser. No. 60/894,680 filed on Mar. 13, 2007. The entirety of the above-mentioned patent application is hereby incorporated by reference herein and made a part of this specification.

### BACKGROUND OF THE INVENTION

1. Field of Invention

The present invention relates to a digital photo display. More particularly, the present invention relates to a digital photo display device suitable for being detachably mounted on any photo frame of user's choice.

2. Description of Prior Art

Photographs are important as they bring back pleasant memories of various special occasions of our lives. Photographic prints relating to childhood, weddings, vacations and other occasions are commonly placed in photo albums, whereby each photo album may be dedicated to a specific occasion.

A conventional photo album holds a plurality of conventional photographic prints, i.e., those recorded on photographic paper. However, as the number of photographic prints in an album becomes substantial, the size of the photo album may become bulky and storage thereof may become a problem. Moreover, if individual photographic prints are not stored in photo albums, simply locating a desired photo print or group of photos may prove to be, if not impossible, a very difficult task amid a large collection of prints.

Accordingly, digital photo displays are developed which provides the convenience of storing digital images of the photographs into a hard drive. Advantageously, digital photo display eliminates the need to store a large number of individual prints. Moreover, a person can easily locate the digital image, e.g., using identification information associated with the image. The conventional digital photo display is configured to record, store and display images, wherein pictures or documents stored in an image memory can be retrieved and displayed on a display. Index information associated with each image allows a particular image to be retrieved from the memory and displayed on the display. The digital photo display may be equipped with a keyboard and editor that allows a user to edit stored images.

The conventional digital photo display comprises a frame, a display screen surrounded by the frame and a housing enclosing the electronic components of the digital photo display, wherein the frame is fixedly attached to the body of the display assembly and has a window corresponding to the display screen. In other words, the frame is not interchangeable, and a user cannot to change the pattern or color of frame of the conventional digital photo display. Despite the conventional digital photo display provides the advantageous features of storing and displaying digital photos in a user-friendly manner, however the appearance of the digital photo display is rather monotonous in appearance.

### SUMMARY OF THE INVENTION

Accordingly, the present invention is directed to a digital photo display.

The present invention provides a digital photo display, and the digital photo display comprises a frame and a digital photo display device. The digital photo display device is detachably mounted into the frame. The digital photo display device comprises a display screen, a housing and a support stand. Wherein the display screen is attached to a first side of the housing and the support stand is pivotally attached to a second side of the housing opposite to the first side. The housing encloses electronic components for performing functional operations of the digital photo display device, and the support stand is a rotatable stand.

According to an embodiment of the present invention, the support stand is a detachable support stand, and the housing has stand base on the second side, wherein the stand base is used to accommodate the support stand.

According to an embodiment of the present invention, the support stand is an extendable-and-rotatable stand for supporting the digital photo display at various angled position.

According to an embodiment of the present invention, the digital photo display device further comprises at least two extendable fixed parts hidden in the second side of the housing. Each of the two extendable fixed parts has a hollow hole. When the frame lacks of pivotal fasteners, the two extendable fixed parts are pulled outside, and two screws are screwed into the frame through the two hollow holes of the two extendable fixed parts to mount the digital photo display device into the frame.

According to an embodiment of the present invention, the housing has a vertical hanging hole, a horizontal hanging hole or both of them, and the vertical hanging hole, a horizontal hanging hole or both of them are set on the second side of the housing.

According to an embodiment of the present invention, the frame is a accessory frame and comprises a plurality of clamps, and a metal fringe is disposed along the periphery of the housing and has a plurality of grooves corresponding to the clamps of the accessory frame. The clamps of the accessory frame may be snapped into the grooves of the metal fringe to removably mount the digital photo display device on the accessory frame.

According to an embodiment of the present invention, the frame is a accessory frame and comprises a plurality of clamps for securing the metal fringe of the digital photo display device into place.

According to an embodiment of the present invention, the frame is a conventional photo frame of the user's choice.

Despite the conventional digital photo display provides the advantageous features of storing and displaying digital photos in a user-friendly manner, however the appearance of the digital photo display is rather monotonous in appearance. But in the present invention the appearance of the digital photo display can be changed to meet the user's desire.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A illustrates front and back views of a conventional photo frame.

FIGS. 1B-1G illustrate various shapes and styles of the frames.

FIGS. 2A-2B illustrate the digital display device 200.

FIGS. 2C-2F illustrate the support stand 208 can be rotated and extended to support the digital photo display device 200 at a desired position on a desired flat platform of an article such as show case, desk, tea table, and the like.

FIGS. 3A-3F illustrate the mounting of the digital photo display device 200 of the present invention into the frame 102 to form the digital photo display 300.

FIGS. 4A-4B illustrate the digital display device 400.

FIGS. 4C-4F illustrate the support stand 408 can be rotated and extended to support the digital photo display device 400 at a desired position on a desired flat platform of an article such as show case, desk, tea table, and the like.

FIGS. 4G-4I illustrate the digital photo display device 400 is mounted on an accessory frame 450 to form the digital photo display 470.

FIG. 5A shows another one embodiment of the present invention provides a digital photo display 550.

FIG. SB shows the second side view of digital photo display device 500.

FIG. 5C illustrates the support stand 508 is a detachable support stand.

FIG. 5D illustrates the support stand 508 is a rotatable support stand.

FIG. 5E shows the side view of the digital photo display device 500.

### DESCRIPTION OF THE EMBODIMENTS

Reference will now be made in detail to the present preferred embodiment of the invention, examples of which are illustrated in the accompanying drawings. Wherever possible, the same reference numbers are used in the drawings and the description to refer to the same or like parts.

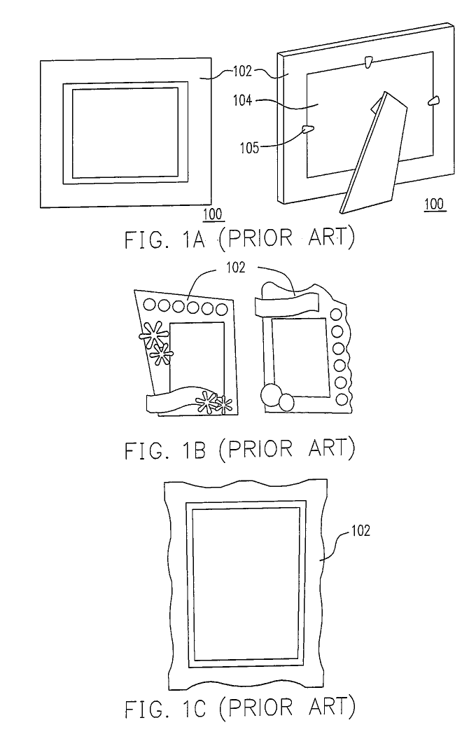

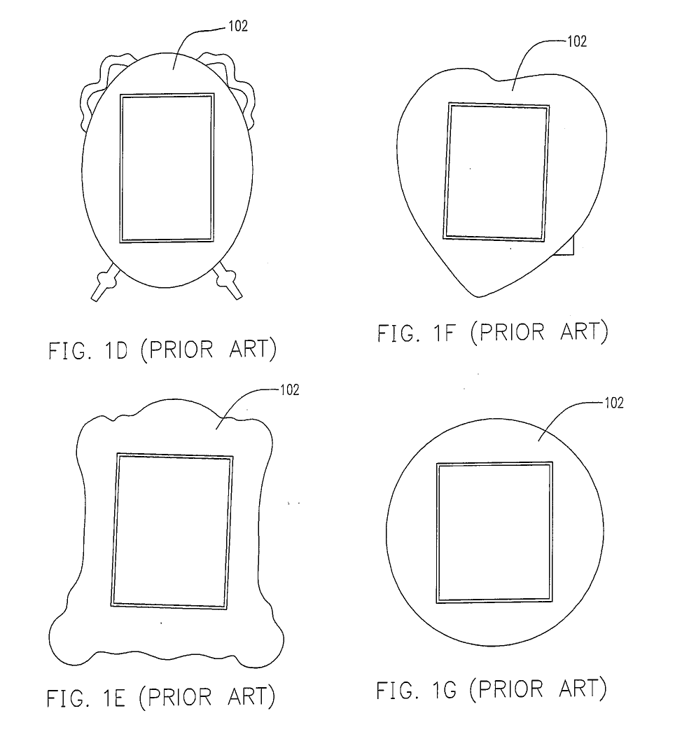

Conventional photo frames are well known in the art. As shown in FIG. 1A, the conventional photo frame 100 comprises a frame 102, a supporting board 104 and a glass 106, which are separate pieces and are secured together to form the photo frame 100. The supporting board 104 may be secured to the frame 102 by pivotal fasteners 105 or the like, and held in place by a force-fit engagement, where the supporting board 104 function to hold the glass 106 and the picture in place within the frame portions. The conventional photo frames 100 are available on the market in various standard sizes such as 4R, 5R, 6R, 7R, 8R, and the like. In addition, the photo frames 102 are also available in various shapes and sizes as shown in FIGS. 1B-1G.

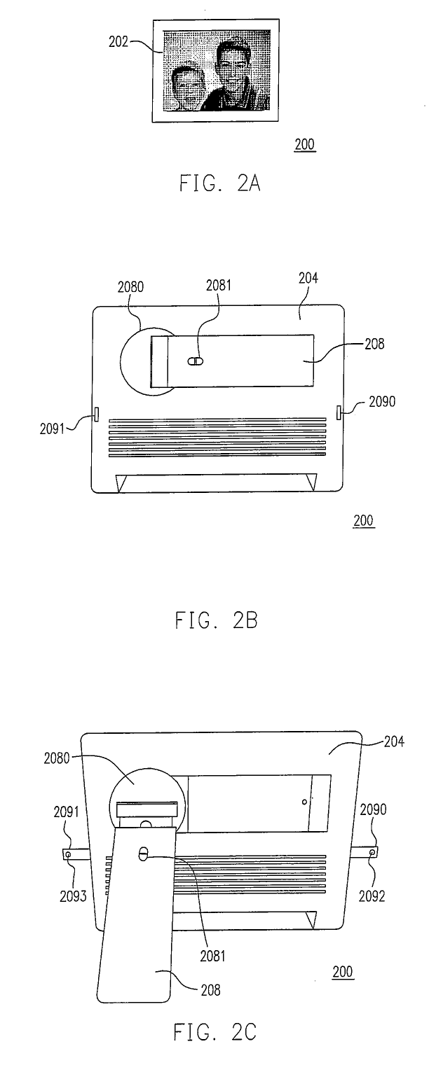

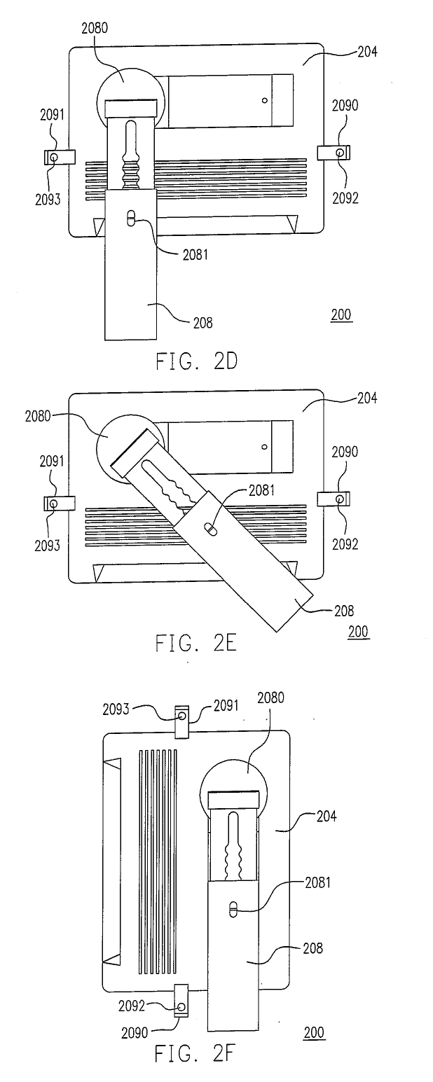

Referring to FIGS. 2A and 2B, the embodiment of the present invention provides a digital photo display device 200. The digital photo display device 200 comprises a display screen 202, a housing 204 and a support stand 208. The display screen 202 is fixed on a first side of the housing 204, and the support stand 208 is pivotally attached to a pivot base 2080 of a second side of the housing 204 opposite to the first side of the housing 204. The housing 204 encloses the various electronic components of the digital photo display device 200 for performing functional operations of digital photo display device 200. The digital photo display device 200 is configured to record, store and display images. The pictures or documents can be stored in an image memory, and can be retrieved and displayed on the display screen 202, wherein index information associated with each image may be utilized to retrieve a particular image from the memory and displayed on the display screen 202. Although not shown, the device may be equipped with a keyboard and an editor that allows a user to edit stored images.

The support stand 208 is an extendable-and-rotatable stand. FIGS. 2C-2F illustrate the support stand 208 can be rotated and extended to support the digital photo display device 200 at a desired position on a desired flat platform of an article such as show case, desk, tea table, and the like. In addition, the support stand 208 can be rotate and extended for vertical or horizontal viewing position. The keylock 2081 is set on the support stand 208 and can be used to control the length of the support stand 208, so as to achieve the extensibility of the support stand 208.

As shown in FIGS. 2C-2F, FIGS. 2C and 2D illustrate the support stand 208 can extend its length, and FIG. 2E illustrate the support stand 208 can rotate. FIGS. 2C and 2F illustrate the support stand 208 can be rotate and extended for vertical or horizontal viewing position.

Additionally, at least two extendable fixed parts 2090 and 2091 are deposited and hidden in the second side of the housing 204. The extendable fixed parts 2090 and 2091 can be pulled outside of the second side of the housing 204 and are used to fasten the digital photo display device 200 with the frame, and more particularly when the frame has no pivotal fasteners to fasten the digital photo display device 200 and the frame. The extendable fixed parts 2090 and 2091 have hollow holes 2092 and 2093. Two -screws can be screwed into the two hollow holes 2092 and 2093 to fasten the frame and the digital photo display device 200.

According to an embodiment of the present invention, the dimension of the digital photo display device 200 may be configured to detachably fit to the frame of any one of the standard size conventional photo frames described above, for example, 4R, 5R, 6R, 7R, 8R, and the like. The dimension of the digital photo display device 200 may be substantially identical to that of the supporting board of the conventional photo frame, and may be detachably secured to the frame by pivotal fasteners or the like, and held in place by a force-fit engagement, where the digital photo display device 200 is detachably held in place within the frame portions of the frame with its screen 202 exposed. Thus, the digital photo display device 200 of the present invention can be detachably mounted on a frame of a conventional photo frame of the user's choice. The digital photo display of the present invention is not only easy to use but also more attractive and elegant in appearance compared to the conventional digital photo display, and can elevate the good feeling and mood of the user to watch the stored digital pictures captured at various events bringing back the pleasant memories.

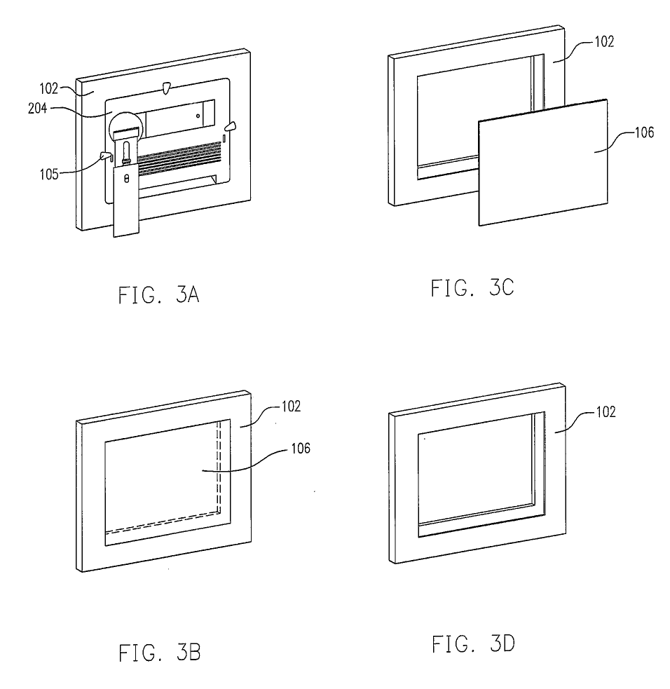

Hereinafter, the mounting of the digital photo display device 200 of the present invention into the frame 102 to form the digital photo display 300 may be described with reference to FIGS. 3A-3E. First, as shown in FIG. 3A, a digital photo display device mounted into the conventional photo frame is provided. The install procedure is described as follows. As shown in FIG. 3B, the supporting board of the conventional photo frame is detached from the frame 102 of the conventional photo frame. Next, as shown in FIG.. 3C, the glass 106 of the conventional photo frame is removed. Next, as shown in FIG. 3D and 3E, the digital photo display device 200 is mounted and detachably secured to the frame portions of the frame 102 using the pivotal fasteners 105. Thus, the mounting of the digital photo display device 200 onto the frame 102 is completed to form the digital photo display 300 of the present invention. FIG. 3E illustrates the digital photo display device 200 is in horizontal viewing position, as stated above the support stand 208 is the extendable-and-rotatable stand, thus the digital photo display device 200 may also in vertical viewing position as illustrated in FIG. 3F.

Although the present invention is illustrated using 4R, 5R, 6R, 7R and 8R photo frames as examples, however, the above description is not intended to limit the scope of the present invention as such, photo frames of various shapes, as shown in FIGS. 1A-1F, and sizes may also be used to practice the present invention which shall also be construed to be within the scope of the present invention.

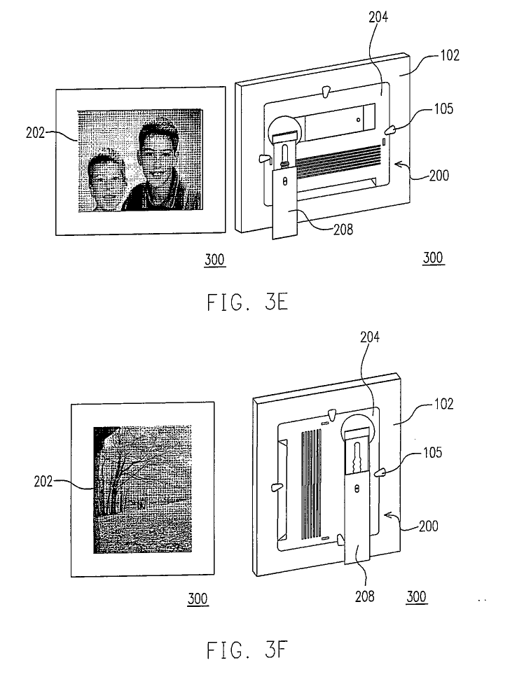

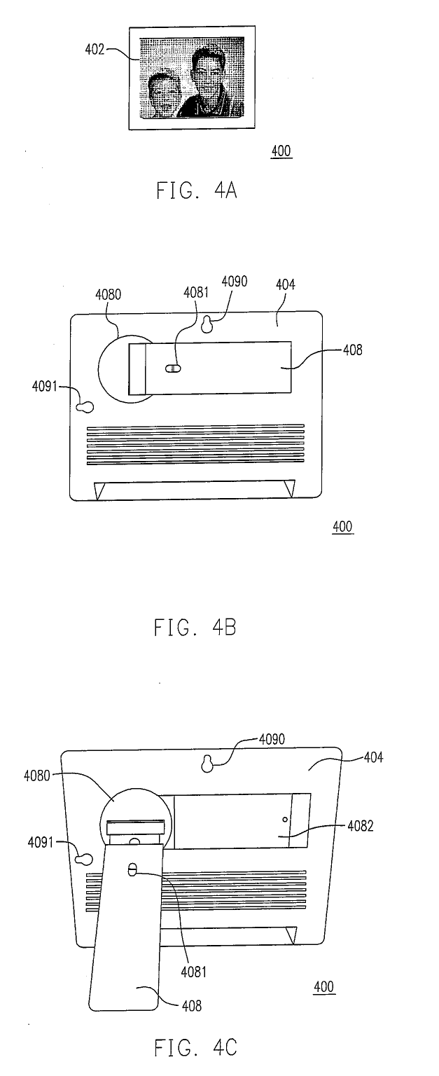

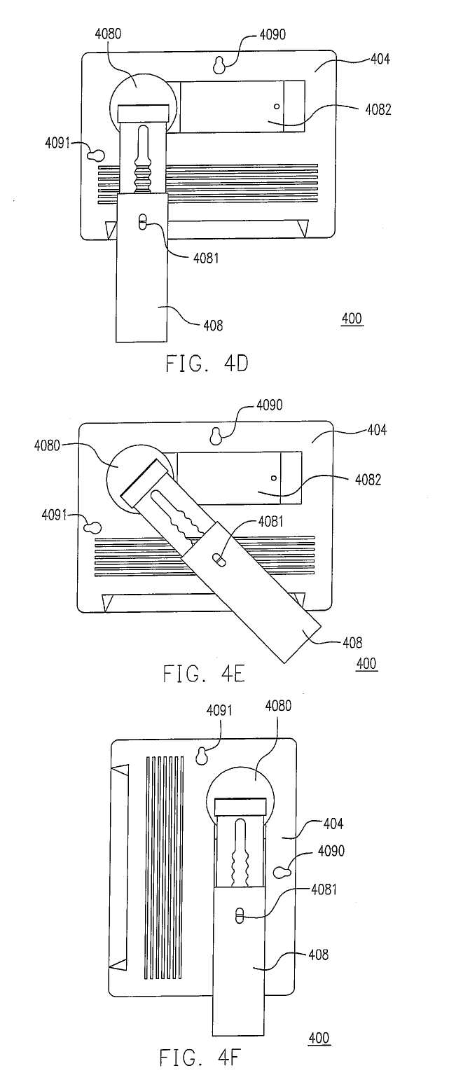

Referring to FIGS. 4A and 4B, another embodiment of the present invention provides a digital photo display device 400. The digital photo display device 400 comprises a display screen 402, a housing 404 and a support stand 408. The display screen 402 is fixed on a first side of the housing 404, and the support stand 408 is pivotally attached to a pivot base 4080 of a second side of the housing 404 opposite to the first side of the housing 404. The housing 404 encloses the various electronic components of the digital photo display device 400 for performing functional operations of digital photo display device 400. The digital photo display device 400 is configured to record, store and display images. The pictures or documents can be stored in an image memory, and can be retrieved and displayed on the display screen 402, wherein index information associated with each image may be utilized to retrieve a particular image from the memory and displayed on the display screen 402. Although not shown, the device may be equipped with a keyboard and an editor that allows a user to edit stored images.

The support stand 408 is an extendable-and-rotatable stand. FIGS. 4C-4F illustrate the support stand 408 can be rotated and extended to support the digital photo display device 400 at a desired position on a desired flat platform of an article such as show case, desk, tea table, and the like. In addition, the support stand 408 can be rotate and extended for vertical or horizontal viewing position. The keylock 4081 is set on the support stand 408 and can be used to control the length of the support stand 408, so as to achieve the extensibility of the support stand 408.

The housing 404 has a vertical hanging hole 4091 and a horizontal hanging hole 4090. The vertical hanging hole 4091 is used to hang the digital photo display device 400 on the wall. Thus by using the vertical hanging hole 4091, the digital photo display device 400 is hung on the wall vertically. The horizontal hanging hole 4090 is used to hang the digital photo display device 400 on the wall. Thus by using the horizontal hanging hole 4090, the digital photo display device 400 is hung on the wall horizontally. Furthermore, the housing 404 has a stand base 4082 to accommodate the support stand 408. When the digital photo display device 400 is hung on the wall, the support stand 408 is accommodated in the stand base 4082. Thus the second side of the housing-now is substantially flat, so as the digital display device 400 can be hung on the wall.

Referring to FIGS. 4G-4I, FIGS. 4G-4I illustrate the digital photo display device 400 is mounted on an accessory frame 450 into which the digital photo display 470 may be detachably mounted. The accessory frame 450 has a plurality of clamps 452 that correspond to the grooves 451 arranged on the metal fringe located along periphery of the digital photo display 470. The digital photo display device 400 may be mounted on the accessory frame 450 and the clamps 452 of the accessory frame 450 may be snapped into the corresponding grooves 451 of the metal fringe as shown in FIGS. 4G and 4I. Alternatively, the accessory frame 450 comprising a plurality of clamps 452 could secure the metal fringe of the digital photo display device into place (not shown).

However the accessory frame 450 is not used to limit the scope of the present invention. The user may optionally detachably attach the digital photo display 470 on a conventional photo frame.

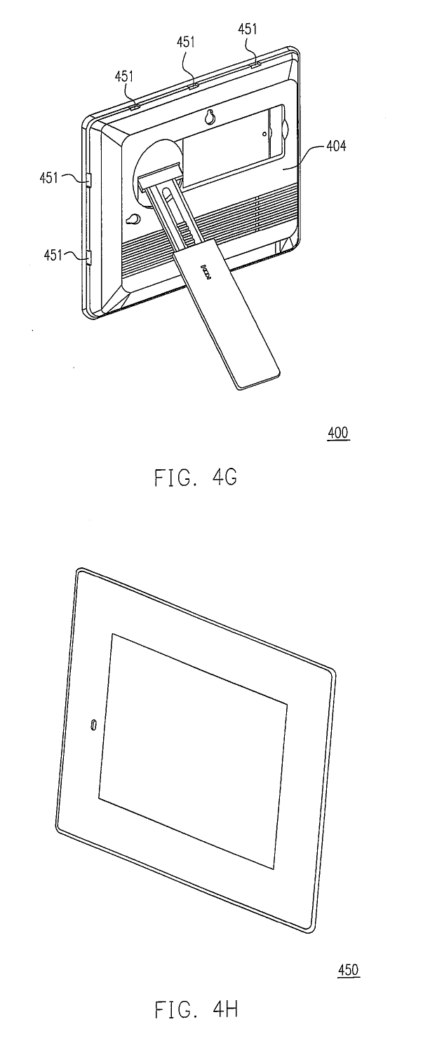

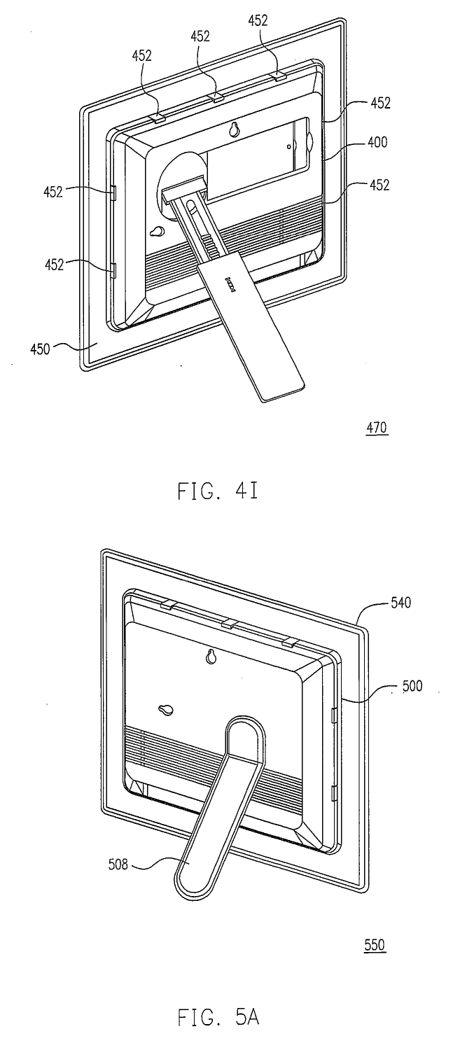

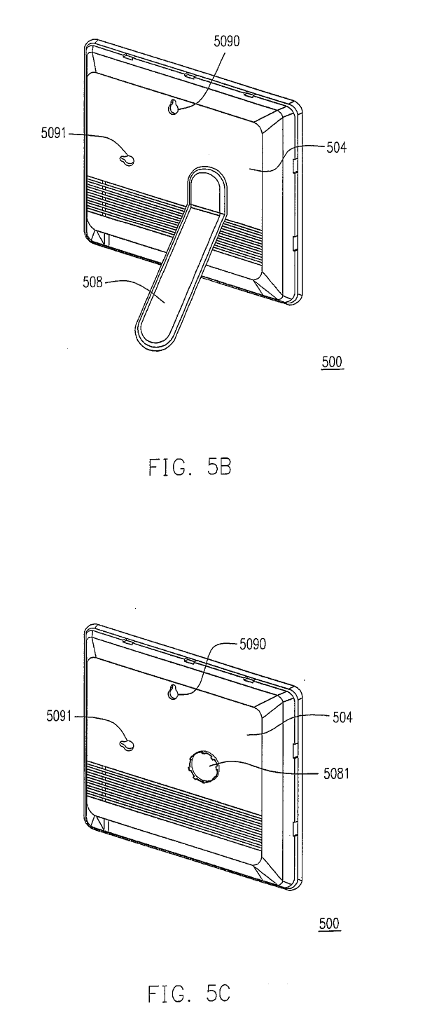

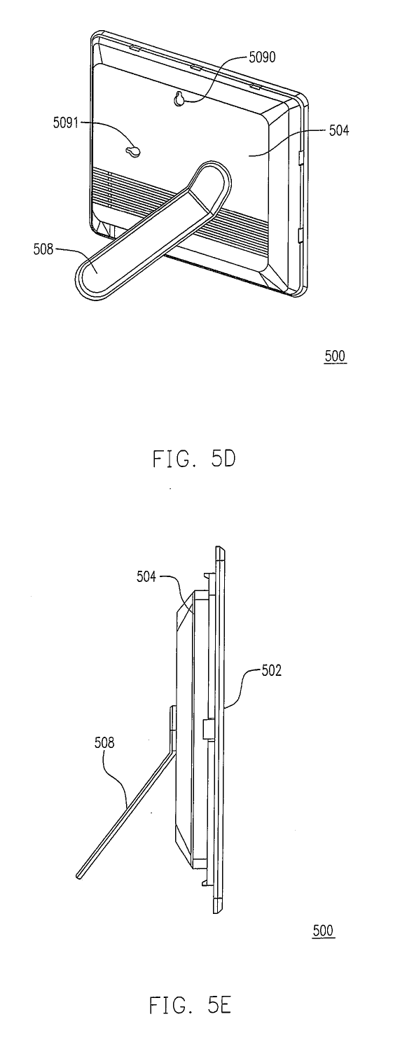

Referring to FIG. 5A, another embodiment of the present invention provides a digital photo display 550. The digital photo display device 500 is mounted on an accessory frame 540 to form the digital photo display 550. Referring to FIG. 5B, FIG. 5B shows the second side view of digital photo display device 500. The digital photo display device 500 comprises a display screen 502 (shown in FIG. 5E), a housing 504 and a support stand 508. The display screen 502 is fixed on a first side of the housing 504, and the support stand 508 is pivotally attached to a pivot base 5081 (shown in FIG. 5C) of a second side of the housing 504 opposite to the first side of the housing 504. The housing 504 encloses the various electronic components of the digital photo display device 500 for performing functional operations of digital photo display device 500. The digital photo display device 500 is configured to record, store and display images. The pictures or documents can be stored in an image memory, and can be retrieved and displayed on the display screen 502, wherein index information associated with each image may be utilized to retrieve a particular image from the memory and displayed on the display screen 502. Although not shown, the device may be equipped with a keyboard and an editor that allows a user to edit stored images.

The housing 504 has a vertical hanging hole 5091 and a horizontal hanging hole 5090. The vertical hanging hole 5091 is used to hang the digital photo display device 500 on the wall. Thus by using the vertical hanging hole 5091, the digital photo display device 500 is hung on the wall vertically. The horizontal hanging hole 5090 is used to hang the digital photo display device 500 on the wall.

Referring to FIG. 5C, FIG. 5C illustrates the support stand 508 is a detachable support stand. The support stand 508 is removably installed in the pivot base 5081. The support stand 508 is removed when the digital photo display device 500 is hung on the wall. Referring to FIG. 5D, FIG. 5D illustrates the support stand 508 is a rotatable support stand. In this embodiment, support stand 508 is non-extendable, however it does not intend to limit the scope of the present invention. Finally referring to FIG. 5E, FIG. 5E shows the side view of the digital photo display device 500. The angle Φ between the second side of the housing 504 and the support stand 508 is about 45°. However it does not intend to limit the scope of the present invention, the angle Φ is larger than 0° and less than 90°.

Though the present invention has been disclosed above by the preferred embodiments, they are not intended to limit the present invention. Anybody skilled in the art can make some modifications and variations without departing-from the spirit and scope of the present invention. Therefore, the protecting range of the present invention falls in the appended claims. Moreover, any embodiment or the claims of the present invention is not supposed to achieve all the objectives, advantages, or features disclosed by the present invention. In addition, the abstract and title are only used to assist the search of patent documents, instead of limiting the scope of the present invention.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A digital photo display, comprising:
a frame; and
a digital photo display device, detachably mounted into the frame, comprising a display screen, a housing and a support stand, wherein the display screen is attached to a first side of the housing and the support stand is attached to a second side of the housing opposite to the first side, and wherein the housing encloses electronic components for performing functional operations of the digital photo display device.

2. The digital photo display according to claim 1, wherein the frame is a frame of one selected from a group consisting of a 4R photo frame, a 5R photo frame, a 6R photo frame, a 7R photo frame and an 8R photo frame.

3. The digital photo display according to claim 1, wherein the support stand is an extendable-and-rotatable stand for supporting the digital photo display at a various angled position.

4. The digital photo display according to claim 1, wherein the support stand is a detachable support stand, and the housing has a stand base on the second side, wherein the stand base is used to accommodate the support stand.

5. The digital photo display according to claim 1, wherein the digital photo display device further comprises at least two extendable fixed parts hidden in the second side of the housing, and each of the two extendable fixed parts has a hollow hole; when the frame lacks of pivotal fasteners, the two extendable fixed parts are pulled outside, and two screws are screwed into the frame through the two hollow holes of the two extendable fixed parts to mount the digital photo display device into the frame.

6. The digital photo display according to claim 1, wherein the digital photo display device comprises a memory for storing pictures or documents, and wherein the stored pictures or documents can be retrieved and displayed on the display screen.

7. The digital photo display according to claim 5, wherein index information associated with each image allows a particular image to be retrieved from the memory and displayed on the display screen.

8. The digital photo display according to claim 1, wherein the frame comprises a rectangular shape, an oval shape, a circular shape, a square shape, a heart shape or an irregular shape.

9. The digital photo display according to claim 1, wherein the housing has a vertical hanging hole, a horizontal hanging hole or both of them, and the vertical hanging hole, a horizontal hanging hole or both of them are set on the second side of the housing.

10. The digital photo display according to claim 1, wherein the frame is a accessory frame comprising a plurality of clamps, and a metal fringe is disposed along the periphery of the housing and has a plurality of grooves corresponding to the clamps of the accessory frame.

11. The digital photo display according to claim 1, wherein the frame is a accessory frame comprising a plurality of clamps for securing the metal fringe of the digital photo display device into place.

12. A digital photo display device suitable for detachably mounting on a frame, comprising:
a housing;
a display screen, attached to a first side of the housing; and
a support stand, pivotally attached to a second side of the housing opposite to the first side, wherein the housing encloses electronic components for performing functional operations of the digital photo display device, and the support stand is a rotatable stand.

13. The digital photo display device according to claim 12, wherein the support stand is a detachable support stand, and the housing has stand base on the second side, wherein the stand base is used to accommodate the support stand.

14. The digital photo display device according to claim 12, wherein the support stand is rotatable stand for vertical or horizontal viewing position.
